(19) United States
(12) Patent Application Publication
(10) Pub. No.: US 2023/0178743 A1
(43) Pub. Date: Jun. 8, 2023

(54) BINDER FOR ALL-SOLID-STATE BATTERY, MANUFACTURING METHOD THEREOF, ELECTRODE FOR ALL-SOLID-STATE BATTERY COMPRISING THE BINDER, AND ALL-SOLIDSTATE BATTERY COMPRISING THE ELECTRODE

(71) Applicant: INDUSTRY-ACADEMIC COOPERATION FOUNDATION, YONSEI UNIVERSITY, Seoul (KR)

(72) Inventors: Yoon Seok JUNG, Seoul (KR); Tae Young Kwon, Seoul (KR); Kyu Tae Kim, Seoul (KR); Dae Yang Oh, Gyeonggi-do (KR)

(73) Assignee: INDUSTRY-ACADEMIC COOPERATION FOUNDATION, YONSEI UNIVERSITY, Seoul (KR)

(21) Appl. No.: 18/062,424

(22) Filed: Dec. 6, 2022

(30) Foreign Application Priority Data
Dec. 7, 2021 (KR) 10-2021-0173976

(51) Int. Cl. H01M 4/62; H01M 10/0562

(52) U.S. Cl. CPC H01M 4/622; H01M 10/0562; H01M 2300/0068

(57) ABSTRACT

The present disclosure relates to a binder for an all-solid-state battery, a method for preparing the binder, an electrode for an all-solid-state battery including the binder, and an all-solid-state battery including the electrode. Particularly, the binder for an all-solid-state battery has a three-dimensional network structure formed by mixing a polymer having unsaturated carbon double bonds, sulfur donor, vulcanization accelerator, first activating agent and a second activating agent in an adequate amount, and then carrying out heat treatment to perform crosslinking through the covalent bonding of carbon in the polymer chains with sulfur. In this manner, it is possible to minimize damages upon the sulfide-based solid electrolyte. In addition, the binder for an all-solid-state battery has a three-dimensional network structure, and thus prevents separation from an electrode substrate and electrode cracking, inhibits swelling and shrinking of the active material in the electrode and allows the materials in the electrode to be in contact with one another, thereby providing significantly improved battery performance.

### CROSS-REFERENCE TO RELATED APPLICATION

This application claims priority to Korean Patent Application No. 10-2021-0173976 filed on Dec. 7, 2021, and all the benefits accruing therefrom under 35 U.S.C. § 119, the contents of which in its entirety are herein incorporated by reference.

### BACKGROUND

### 1. Field

The present disclosure relates to a binder for an all-solid-state battery, a method for preparing the binder, an electrode for an all-solid-state battery including the binder, and an all-solid-state battery including the electrode.

### 2. Description of the Related Art

Electrode slurry for an all-solid-state battery uses its constitutional elements, such as an active material, a solid electrolyte, a conductive material and a binder, and an organic solvent capable of dispersing such elements homogeneously. Particularly, the binder includes a rubber-based polymer having physical properties allowing electrode formation and battery operation, considering the reactivity with the solid electrolyte and dispersion in the organic solvent.

However, such a rubber-based polymer binder causes separation from the substrate and electrode cracking during the drying of the electrode, or cannot satisfy such a level that a change in volume of the active material in the electrode may be inhibited during the operation of the battery.

Meanwhile, a crosslinking structure may be applied generally in order to improve the physical properties of a polymer. However, most of the crosslinking mechanisms severely react with a sulfide-based solid electrolyte through polar interaction to cause damages in the solid electrolyte.

Therefore, there is a need for research and development of a novel binder material which has such a level of physical properties that it may minimizes damages on the sulfide-based solid electrolyte, may cause no separation from the electrode substrate and electrode cracking and may inhibit swelling and shrinking of the active material in the electrode, as well as can provide improved battery performance.

### REFERENCES

### Patent Documents

(Patent Document 1) Korean Patent Publication No. 10-2184881

### SUMMARY

To solve the above-mentioned problems, the present disclosure is directed to providing a binder for an all-solid-state battery, having a three-dimensional network structure formed by the covalent bonding of carbon with sulfur through the crosslinking of polymer chains with sulfur.

The present disclosure is also directed to providing a solid electrolyte layer of an all-solid-state battery, including the binder and a sulfide-based solid electrolyte.

In addition, the present disclosure is directed to providing an electrode for an all-solid-state battery, including the binder, a sulfide-based solid electrolyte and an electrode active material.

In addition, the present disclosure is directed to providing an all-solid-state battery including the solid electrolyte layer and the electrode.

In addition, the present disclosure is directed to providing a device including the all-solid-state battery.

In addition, the present disclosure is directed to providing an electric device including the electrode for an all-solid-state battery.

In addition, the present disclosure is directed to providing a method for preparing a binder for an all-solid-state battery.

In addition, the present disclosure is directed to providing a method for preparing a solid electrolyte layer for an all-solid-state battery.

Further, the present disclosure is directed to providing a method for manufacturing an electrode for an all-solid-state battery.

In one aspect, there is provided a binder for an all-solid-state battery, having a three-dimensional structure formed by the covalent bonding of carbon with sulfur through the heat treatment of a binder composition, wherein the binder composition includes, based on 100 parts by weight of a polymer having unsaturated carbon double bonds, 1-30 parts by weight of a sulfur donor, and an organic solvent, and optionally includes 0.5-4 parts by weight of a vulcanization accelerator, 3-10 parts by weight of a first activating agent, and 1-4 parts by weight of a second activating agent.

In another aspect, there is provided a solid electrolyte layer for an all-solid-state battery, including the binder and a sulfide-based solid electrolyte.

In still another aspect, there is provided an electrode for an all-solid-state battery, including the binder, a sulfide-based solid electrolyte and an electrode active material.

In still another aspect, there is provided an all-solid-state battery, including a positive electrode layer; a negative electrode layer; and the solid electrolyte layer interposed between the positive electrode layer and the negative electrode layer, wherein at least one of the positive electrode layer and the negative electrode layer includes the binder.

In still another aspect, there is provided a device including the all-solid-state battery, the device being a transport device or energy storage device.

In still another aspect, there is provided an electric device including the electrode for an all-solid-state battery, the electric device being any one selected from electric vehicles, hybrid electric vehicles, plug-in hybrid electric vehicles and electric power storage devices.

In still another aspect, there is provided a method for preparing a binder for an all-solid-state battery, including the steps of: dispersing 100 parts by weight of a polymer having unsaturated carbon double bonds, 1-30 parts by weight of a sulfur donor, 0.5-4 parts by weight of a vulcanization accelerator, 3-10 parts by weight of a first activating agent and 1-4 parts by weight of a second activating agent in an organic solvent to prepare a binder composition; and heat treating the binder composition to obtain a binder for an all-solid-state battery, having a three-dimensional network structure formed by the covalent bonding of carbon with sulfur.

In still another aspect, there is provided a method for preparing a solid electrolyte layer for an all-solid-state battery, including the steps of: preparing a slurry composition for a solid electrolyte, including the binder composition and a sulfide-based solid electrolyte; and casting the slurry composition for a solid electrolyte onto a substrate and carrying out heat treatment to form a solid electrolyte layer.

In still another aspect, there is provided a method for manufacturing an electrode for an all-solid-state battery, including the steps of: preparing an electrode slurry composition including the binder composition, a sulfide-based solid electrolyte, an electrode active material and a conductive material; and casting the electrode slurry composition onto a substrate and carrying out heat treatment to obtain an electrode for an all-solid-state battery.

The binder for an all-solid-state battery according to the present disclosure has a three-dimensional network structure formed by mixing a polymer having unsaturated carbon double bonds, a sulfur donor, a vulcanization accelerator, a first activating agent and a second activating agent in an adequate amount, and then carrying out heat treatment to perform crosslinking through the covalent bonding of carbon in the polymer chains with sulfur. In this manner, it is possible to minimize damages on the sulfide-based solid electrolyte.

In addition, the binder for an all-solid-state battery according to the present disclosure has a three-dimensional network structure to prevent separation from an electrode substrate and electrode cracking and to inhibit swelling and shrinking of the active material in the electrode, thereby providing significantly improved battery performance.

The effects of the present disclosure are not limited to the above-mentioned effects. It is to be understood that the effects of the present disclosure include all of the effects that may be inferred from the following description.

### BRIEF DESCRIPTION OF THE DRAWINGS

FIG. 1 is a schematic flow chart illustrating the method for manufacturing an electrode for an all-solid-state battery according to an embodiment of the present disclosure.

FIG. 2 is a graph illustrating the results of Raman spectrometry of the binder composition for an all-solid-state battery according to each of Examples 1-3 and Comparative Example 1.

FIG. 3 is a graph illustrating the results of X-ray diffractometry (XRD) of the sulfide-based solid electrolyte layer prepared by mixing the binder composition for an all-solid-state battery according to each of Examples 1-3 and Comparative Example 1 with a sulfide-based solid electrolyte.

FIG. 4 is a graph illustrating the tensile strength test results of the binder composition for an all-solid-state battery according to each of Examples 1-3 and Comparative Example 1.

FIG. 5 is a graph illustrating the results of evaluation of the initial charge/discharge cycle voltage Vs. capacity of the all-solid-state battery including the electrode according to each of Examples 1-3 and Comparative Example 1.

FIG. 6 is a graph illustrating the results of evaluation of the rate characteristics of the all-solid-state battery including the electrode according to each of Examples 1-3 and Comparative Example 1, depending on the charge/discharge cycle.

FIG. 7 is a graph illustrating the results of evaluation of the life characteristics of the all-solid-state battery including the electrode according to each of Examples 1-3 and Comparative Example 1, depending on the charge/discharge cycle.

FIG. 8 is a stress-strain graph obtained through the tensile strength test of the binder for an all-solid-state battery according to each of Example 2 and Comparative Example 1.

FIG. 9 is a graph illustrating the mechanical properties of the binder for an all-solid-state battery according to each of Example 1-3, as determined by the nano-indentation method.

FIG. 10 shows a schematic view and graph illustrating the real-time pressure measurement test depending on the charge/discharge cycle of the all-solid-state battery including the electrode according to each of Example 2 and Comparative Example 1.

FIG. 11 is a scanning electron microscopic image illustrating the all-solid-state battery including the electrode according to each of Example 2 and Comparative Example 1 depending on the charge/discharge cycle.

FIG. 12 is a graph illustrating the test results of rate characteristics of the all-solid-state battery including the electrode according to each of Examples 1-3 and Comparative Example 1, depending on the battery driving pressure.

FIG. 13 shows a graph illustrating the initial charge/discharge cycle voltage Vs. capacity test results of the pouch-type all-solid-state battery, including the electrode according to each of Example 2 and Comparative Example 1 and a solid electrolyte membrane, and a graph illustrating the life characteristics depending on the charge/discharge cycle.

FIG. 14 is a graph illustrating the mechanical properties of the electrode according to each of Example 2 and Comparative Example 1, as determined by the nano-indentation method.

### DETAILED DESCRIPTION

Hereinafter, the present disclosure will be explained in more detail with reference to particular embodiments.

The present disclosure relates to a binder for an all-solid-state battery, a method for preparing the same, an electrode for an all-solid-state battery including the binder, and an all-solid-state battery including the electrode.

As described above, a rubber-based polymer binder used in the electrode slurry for an electrode for an all-solid-state battery based on a sulfide-based solid electrolyte causes separation from a substrate and electrode cracking during the drying of the electrode, or cannot satisfy such a level that a change in volume of the active material in the electrode may be inhibited during the operation of the battery.

To solve this, the binder for an all-solid-state battery according to the present disclosure has a three-dimensional network structure formed by mixing a polymer having unsaturated carbon double bonds, a sulfur donor, a vulcanization accelerator, a first activating agent and a second activating agent in an adequate amount, and then carrying out heat treatment to perform crosslinking through the covalent bonding of carbon in the polymer chains with sulfur. In this manner, it is possible to minimize damages on the sulfide-based solid electrolyte. In addition, the binder for an all-solid-state battery according to the present disclosure has a three-dimensional network structure to prevent separation from an electrode substrate and electrode cracking and to inhibit swelling and shrinking of the active material in the electrode, thereby providing significantly improved battery performance.

In one aspect of the present disclosure, there is provided a binder for an all-solid-state battery, having a three-dimensional structure formed by heat treating a binder composition including, based on 100 parts by weight of a polymer having unsaturated carbon double bonds, 1-30 parts by weight of a sulfur donor, 0.5-4 parts by weight of a vulcanization accelerator, 3-10 parts by weight of a first activating agent, 1-4 parts by weight of a second activating agent and the balance amount of an organic solvent to form a three-dimensional network structure through the covalent bonding of carbon with sulfur.

The polymer having unsaturated carbon double bonds is one having crosslinkable unsaturated carbon double bonds (—CH═CH—) and is characterized in that it has excellent mechanical properties. Particular examples of the polymer may include at least one selected from the group consisting of natural rubber (NR), butadiene rubber (BR), styrene-butadiene rubber (SBR), acrylonitrile-butadiene rubber (NBR), isobutylene-isoprene rubber (IIR) and ethylene propylene rubber (EPDM). Preferably, the polymer may be at least one selected from the group consisting of natural rubber, butadiene rubber and styrene-butadiene rubber, most preferably, butadiene rubber.

The sulfur donor may be added in order to form a binder having a three-dimensional structure through the covalent bonding with the polymer having unsaturated carbon double bonds. The sulfur donor may be used in an amount of 1-30 parts by weight, preferably 1-15 parts by weight, more preferably 1-10 parts by weight, and most preferably 1-3 parts by weight, based on 100 parts by weight of the polymer. Herein, when the content of the sulfur donor is less than 1 part by weight, the content of sulfur crosslinked with the polymer chains is excessively small, thereby making it difficult to form a binder having a three-dimensional network structure. On the other hand, when the content of the sulfur donor is larger than 30 parts by weight, stiff hard rubber is formed, thereby making it difficult for the binder to perform its function.

The sulfur donor may include elementary sulfur or an organic sulfur donor, preferably elementary sulfur. The organic sulfur donor may be at least one selected from the group consisting of thiuram disulfide (TMTD), 4,4′-dithiodimorpholine (DTDM), dipentamethyl thiuram tetrasulfide (DPTT) and thiocarbamyl sulfenamide (OTOS).

The vulcanization accelerator may be added in order to further improve the crosslinking of the carbon in the polymer chains with sulfur, and may be used in an amount of 0.5-4 parts by weight, preferably 1-3 parts by weight, and most preferably 1.8-1.3 parts by weight, based on 100 parts by weight of the polymer. When the content of the vulcanization accelerator is less than 0.5 parts by weight, the polymer chains cannot be crosslinked sufficiently with sulfur, thereby making it difficult to form a three-dimensional network structure. On the other hand, when the content of the vulcanization accelerator is larger than 4 parts by weight, carbon may be bound excessively with sulfur to cause high brittleness, thereby making it difficult for the binder to perform its function.

The vulcanization accelerator may be at least one selected from the group consisting of thiazole-based, aldehyde amine-based, guanidine-based, thiophosphate-based, sulfenamide-based, thiourea-based, thiuram-based, dithiocarbamate-based and xanthate-based compounds, preferably thiazole-based compounds.

The thiazole-based compound may include at least one selected from the group consisting of 2-mercaptobenzothiazole (MBT), 2,2′-dithiobis(benzothiazole (MBTS) and zinc-2-mercaaptobenzothiazole (ZMBT), preferably 2-mercaptobenzothiazole.

The aldehyde amine-based compound may include heptaldehyde-aniline condensation product (BA), and the guanidine-based compound may include diphenyl guanidine (DPG), N,N′-diorthotolyl guanidine (DOTG) or a mixture thereof.

The thiophosphate-based compound may include zinc-O,O-di-N-phosphorodithioate (ZBDP), and the sulfenamide-based compound may include at least one selected from the group consisting of N-cyclohexyl-2-benzothiazole sulfenamide (CBS), N-tert-butyl-2-benzothiazole sulfenamide (TBBS), 2-(4-morpholinothio)-benzothiazole (MBS) and N,N′-dicyclohexyl-2-benzothiazole sulfenamide (DCBS).

The thiourea-based compound may include at least one selected from the group consisting of ethylene thiourea (ETU), dipentamethylene thiourea (DPTU) and dibutyl thiourea (DBTU).

The thiuram-based compound may include at least one selected from the group consisting of tetramethylthiuram monosulfide (TMTM), tetramethylthiuram disulfide (TMTD), dipentamethylenethiuram tetrasulfide (DPTT) and tetrabenzylthiuram disulfide (TBzTD).

The dithiocarbamate-based compound may include at least one selected from the group consisting of zinc dimethyldithiocarbamate (ZDMC), zinc diethyldithiocarbamate (ZDEC), zinc dibutyldithiocarbamate (ZDBC) and zinc dibenzyldithiocarbamate (ZDBC).

The xanthate-based compound may include zinc-isopropyl xanthate (ZIX).

The first activating agent and the second activating agent may be added to impart an effect of activating the crosslinking during the step of vulcanization through heat treatment. The first activating agent may be used in an amount of 3-10 parts by weight, preferably 4-7 parts by weight, and most preferably 4-6 parts by weight, based on 100 parts by weight of the polymer. Herein, a content of the first activating agent of less than 3 parts by weight cannot provide the crosslinking with a sufficient activation effect. On the other hand, a content of the first activating agent of larger than 10 parts by weight cannot provide a further increase in the activation effect.

The first activating agent may include ZnO, Zn₂SiO₄ or a mixture thereof, preferably ZnO.

The second activating agent may be used in an amount of 1-4 parts by weight, preferably 1-3 parts by weight, and most preferably 1-2 parts by weight, based on 100 parts by weight of the polymer. Herein, a content of the second activating agent of less than 1 part by weight cannot provide the crosslinking with a sufficient activation effect. On the other hand, a content of the second activating agent of larger than 4 parts by weight cannot provide a further increase in the activation effect.

The second activating agent may include a fatty acid, which may be stearic acid.

The binder for an all-solid-state battery may include the first activating agent and the second activating agent mixed at a weight ratio of 3-5:1, preferably 4-5:1. Herein, when the mixing ratio of the first active agent to the second activating agent does not satisfy the above-defined range, crosslinking cannot be performed properly, or the binder cannot realize desired physical properties.

The organic solvent may be used to disperse the polymer, the sulfur donor, the vulcanization accelerator, the first activating agent and the second activating agent homogeneously. The organic solvent has such a level of boiling point and vapor pressure that it may be removed completely under the heat treatment condition of temperature and time by which vulcanization is accomplished. It is preferred to use an organic solvent ingredient having low reactivity with a sulfide-based solid electrolyte.

Particular examples of the organic solvent include at least one selected from the group consisting of butyl butyrate, hexyl butyrate, benzyl acetate, o-xylene, toluene, dibromomethane and anisole. Preferably, the organic solvent may be butyl butyrate, hexyl butyrate or a mixture thereof, preferably butyl butyrate.

The binder for an all-solid-state battery may have a three-dimensional structure formed by the covalent bonding of carbon in the polymer chains of the polymer having unsaturated carbon double bonds with sulfur through the vulcanization step using heat treatment. Since the binder includes such a three-dimensional network structure, it is possible to inhibit swelling and shrinking of the active material in the electrode and to allow the materials in the electrode to be in contact with one another.

The binder for an all-solid-state battery shows a polysulfide bond peak and disulfide bond peak in a wavelength range of 435-445 cm⁻¹ and 500-510 cm⁻¹, respectively, as analyzed by Raman spectrometry. The ratio of the intensity of the polysulfide bond peak/disulfide bond peak may be 1.1-3.1, preferably 1.4-1.8.

In another aspect of the present disclosure, there is provided a solid electrolyte layer for an all-solid-state battery, including the binder and a sulfide-based solid electrolyte.

In still another aspect, there is provided an electrode for an all-solid-state battery, including the binder, a sulfide-based solid electrolyte and an electrode active material.

The electrode may be a positive electrode or a negative electrode.

In still another aspect, there is provided an all-solid-state battery, including a positive electrode layer; a negative electrode layer; and the solid electrolyte layer interposed between the positive electrode layer and the negative electrode layer, wherein at least one of the positive electrode layer and the negative electrode layer includes the binder.

The all-solid-state battery may be a pouch, prismatic or cylindrical battery system obtained by the method according to the present disclosure.

In still another aspect, there is provided a device including the all-solid-state battery, the device being a transport device or an energy storage device.

In still another aspect, there is provided an electric device including the electrode for an all-solid-state battery, the electric device being any one selected from electric vehicles, hybrid electric vehicles, plug-in hybrid electric vehicles and electric power storage devices.

In still another aspect, there is provided a method for preparing a binder for an all-solid-state battery, including the steps of: dispersing 100 parts by weight of a polymer having unsaturated carbon double bonds, 1-30 parts by weight of a sulfur donor, 0.5-4 parts by weight of a vulcanization accelerator, 3-10 parts by weight of a first activating agent and 1-4 parts by weight of a second activating agent in an organic solvent to prepare a binder composition; and heat treating the binder composition to obtain a binder for an all-solid-state battery having a three-dimensional network structure formed by the covalent bonding of carbon with sulfur.

The polymer having unsaturated carbon double bonds is one having crosslinkable unsaturated carbon double bonds (—CH═CH—). Particular examples of the polymer may include at least one selected from the group consisting of natural rubber (NR), butadiene rubber (BR), styrene-butadiene rubber (SBR), acrylonitrile-butadiene rubber (NBR), isobutylene-isoprene rubber (IIR) and ethylene propylene rubber (EPDM). Preferably, the polymer may be at least one selected from the group consisting of natural rubber, butadiene rubber and styrene-butadiene rubber, most preferably, butadiene rubber.

The sulfur donor may include elementary sulfur or an organic sulfur donor, preferably elementary sulfur. The organic sulfur donor may be at least one selected from the group consisting of thiuram disulfide (TMTD), 4,4′-dithiodimorpholine (DTDM), dipentamethyl thiuram tetrasulfide (DPTT) and thiocarbamyl sulfenamide (OTOS).

The vulcanization accelerator may be at least one selected from the group consisting of thiazole-based, aldehyde amine-based, guanidine-based, thiophosphate-based, sulfenamide-based, thiourea-based, thiuram-based, dithiocarbamate-based and xanthate-based compounds, preferably thiazole-based compounds.

The first activating agent may include ZnO, Zn₂SiO₄ or a mixture thereof, preferably ZnO.

The second activating agent may include a fatty acid, which may be stearic acid.

The binder for an all-solid-state battery may include the first activating agent and the second activating agent mixed at a weight ratio of 3-5:1, preferably 4-5:1.

Particular examples of the organic solvent include at least one selected from the group consisting of butyl butyrate, hexyl butyrate, benzyl acetate o-xylene, toluene, dibromomethane and anisole. Preferably, the organic solvent may be butyl butyrate, hexyl butyrate or a mixture thereof, preferably butyl butyrate.

The step of preparing a binder for an all-solid-state battery includes carrying out heat treatment to remove the organic solvent in the binder composition, and no additional step is required, since carbon in the polymer chains is crosslinked with sulfur by the vulcanization treatment through heating.

The heat treatment may be carried out at a temperature of 120-180° C., preferably 130-170° C., under vacuum or inert atmosphere, most preferably 140-160° C. under vacuum, for 10-14 hours. Herein, when the heat treatment temperature is lower than 120° C., covalent bonding between carbon and sulfur cannot be formed sufficiently, thereby making it difficult to form a binder having a three-dimensional network structure. On the other hand, when the heat treatment temperature is higher than 180° C., the polymer may be deformed, or the binder may undergo a change in physical properties due to such a high temperature.

The inert atmosphere may include at least one inert gas selected from the group consisting of argon, helium, neon and nitrogen, preferably argon or nitrogen.

The method for preparing a binder for an all-solid-state battery accomplishes covalent bonding of carbon in the polymer chains with sulfur by the vulcanization treatment through heating to form a three-dimensional network structure, unlike the conventional crosslinking process using polar interaction. Therefore, it is possible to minimize damages on the sulfide-based solid electrolyte. In addition, while crosslinking is carried out, it is possible to improve the mechanical properties of the binder. Particularly, it is possible to finely control the physical properties of the binder and to improve the performance of a battery, by controlling the type and content of each of the additives including the sulfur donor, the vulcanization accelerator, the first activating agent and the second activating agent, and optimizing the heat treatment condition.

Particularly, although it is not clearly stated in the following Examples and Comparative Example, the following 9 conditions in the method for preparing a binder for an all-solid-state battery according to the present disclosure were varied to obtain binders, and each binder was incorporated to a solid electrolyte layer and an electrode layer, which, in turn, were used to obtain an all-solid-state battery. The resultant all-solid-state batteries were charged/discharged 1000 times in the conventional manner, and then tested in terms of durability, oxidation stability, charge/discharge capacity, battery life characteristics and capacity retention.

As a result, unlike the other conditions and numeral ranges, when all of the following conditions are satisfied, separation from the electrode substrate and electrode cracking did not occur even after 1000 charge/discharge cycles, and the all-solid-state battery showed excellent durability and oxidation stability by virtue of the strong binding force between the electrode active material and the solid electrolyte. In addition, the all-solid-state battery retained a high level of charge/discharge capacity, showed a significantly low decrease in output density of about 10% or less after 1000 charge/discharge cycles, realized a high capacity retention of 90% or more, and thus provided significantly improved battery performance.

\textcircled{1} The polymer having unsaturated carbon double bonds is butadiene rubber (BR), \textcircled{2} the sulfur donator is elementary sulfur, \textcircled{3} the vulcanization accelerator is 2-mercaptobenzothiazole (MBT), \textcircled{4} the first activating agent is ZnO, \textcircled{5} the second activating agent is stearic acid, \textcircled{6} the binder for an all-solid-state battery includes the first activating agent and the second activating agent are mixed at a weight ratio of 4-5:1, \textcircled{7} the organic solvent is butyl butyrate, \textcircled{8} the heat treatment in the step of preparing a binder for an all-solid-state battery is carried out at a temperature of 140-160° C. under vacuum for 10-14 hours, and \textcircled{9} the binder for an all-solid-state battery shows a polysulfide bond peak and disulfide bond peak in a wavelength range of 435-445 cm⁻¹ and 500-510 cm⁻¹, respectively, as analyzed by Raman spectrometry, wherein the ratio of the intensity of the polysulfide bond peak/disulfide bond peak may be 1.4-1.8.

However, when any one of the 9 conditions is not satisfied, separation from the electrode substrate and electrode cracking occurred from the 500th charge/discharge cycle, and the all-solid-state battery showed rapid degradation of durability. In addition, the all-solid-state battery showed a significant decrease in charge/discharge capacity, as the number of cycles is increased, a decrease in output density of about 40% or more after 500 charge/discharge cycles, and a low capacity retention of less than 70%.

In still another aspect, there is provided a method for preparing a solid electrolyte layer for an all-solid-state battery, including the steps of: preparing a slurry composition for a solid electrolyte, including the binder composition and a sulfide-based solid electrolyte; and casting the slurry composition for a solid electrolyte onto a substrate and carrying out heat treatment to form a solid electrolyte layer.

The heat treatment may be carried out at a temperature of 120-180° C., preferably 130-170° C., under vacuum or inert atmosphere, most preferably 140-160° C. under vacuum, for 10-14 hours.

In still another aspect, there is provided a method for manufacturing an electrode for an all-solid-state battery, including the steps of: preparing an electrode slurry composition including the binder composition, a sulfide-based solid electrolyte, an electrode active material and a conductive material; and casting the electrode slurry composition onto a substrate and carrying out heat treatment to obtain an electrode for an all-solid-state battery.

The heat treatment may be carried out at a temperature of 120-180° C., preferably 130-170° C., under vacuum or inert atmosphere, most preferably 140-160° C. under vacuum, for 10-14 hours.

The electrode for an all-solid-state battery may include 67-79.5 wt % of an electrode active material, 20-30 wt % of a sulfide-based solid electrolyte and 0.5-3 wt % of the binder.

The electrode for an all-solid-state battery includes the binder having a three-dimensional network structure, and thus allows application of electrode slurry to a current collector even with a small amount, shows excellent moldability, prevents separation from the electrode substrate and electrode cracking, and thus can improve the battery performance.

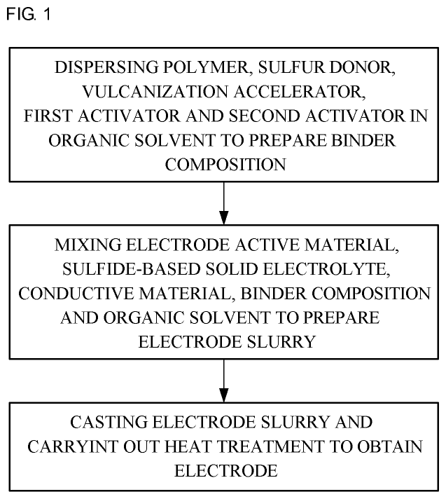

FIG. 1 is a schematic flow chart illustrating the method for manufacturing an electrode for an all-solid-state battery according to the present disclosure. Referring to FIG. 1, a polymer, a sulfur donor, a vulcanization accelerator, a first activating agent and a second activating agent are dispersed in an organic solvent to prepare a binder composition. Next, the binder composition, an electrode active material, a sulfide-based solid electrolyte and a conductive material are mixed with an organic solvent to prepare an electrode slurry. Then, the electrode slurry is cast on a substrate and heat treatment is carried out to obtain an all-solid-state battery.

Hereinafter, the present disclosure will be explained in detail with reference to Examples, Comparative Example and Test Examples, but the scope of the present disclosure is not limited thereto.

### Examples 1-3 and Comparative Example 1

(1) Preparation of Binder for all-Solid-State Battery

Prepared were butadiene rubber (BR) as a polymer, sulfur (S) as a sulfur donor, 2-mercaptobenzothiazole (MBT) as a vulcanization accelerator, zinc oxide (ZnO) as a first activating agent and stearic acid as a second activator.

The polymer, the sulfur donor, the vulcanization accelerator, the first activator and the second activator were mixed at the ratio as shown in the following Table 1 to prepare a binder composition for an all-solid-state battery.

TABLE 1

| | | | | | Second |
|---|---|---|---|---|---|
| | | Sulfur | Vulcanization | First | activator |
| | Polymer | donor | accelerator | activator | (stearic |
| | (BR) | (S) | (MBT) | (ZnO) | acid) |
| | (parts by | (parts by | (parts by | (parts by | (parts by |
| | weight) | weight) | weight) | weight) | weight) |
| Ex. 1 | 100 | 3 | 1 | 5 | 1 |
| Ex. 2 | 100 | 2 | 2 | 5 | 1 |
| Ex. 3 | 100 | 1 | 3 | 5 | 1 |
| Comp. | 100 | — | — | — | — |
| Ex. 1 | | | | | |

(2) Manufacture of Electrode for all-Solid-State Battery

Butyl butyrate as an organic solvent was mixed with 1.5 wt % of the binder composition for an all-solid-state battery according to each of Examples 1-3 and Comparative Example 1, 70 wt % of LiNi_{0.7}Co_{0.15}Mn_{0.15}O₂ 70 as an electrode active material, 27.5 wt % of Li₆PS₅Cl_{0.5}Br_{0.5} as a solid electrolyte and 1 wt % of Super C65 as a conductive material to prepare an electrode slurry. Then, the electrode slurry was cast onto a substrate, and heat treatment was carried out at a temperature of 150° C. for 12 hours to obtain an electrode for an all-solid-state battery.

### Test Example 1: Raman Spectrometry

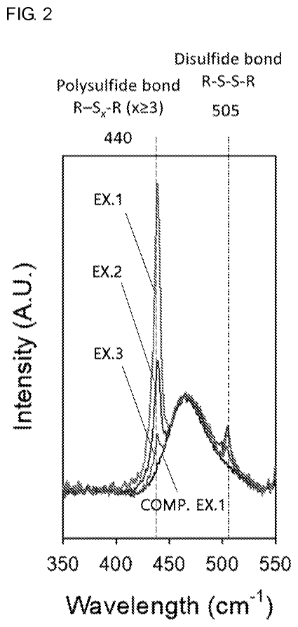

To determine whether carbon-sulfur bonding is formed or not in the binder composition for an all-solid-state battery according to each of Examples 1-3 and Comparative Example 1, Raman spectrometry was carried out. The results are shown in FIG. 2. Herein, Raman spectrometry was carried out by using an Ar-ion laser with a wavelength of 514 nm.

FIG. 2 is a graph illustrating the results of Raman spectrometry of the binder composition for an all-solid-state battery according to each of Examples 1-3 and Comparative Example 1. Referring to FIG. 2, unlike Comparative Example 1, peaks representing carbon-sulfur bonding are detected in Examples 1-3. Particularly, a polysulfide bond peak and a disulfide bond peak are detected in a wavelength range of 435-445 cm⁻¹ and 500-510 cm⁻¹, respectively. This suggests that vulcanization is performed successively.

### Test Example 2: X-Ray Diffractometry (XRD)

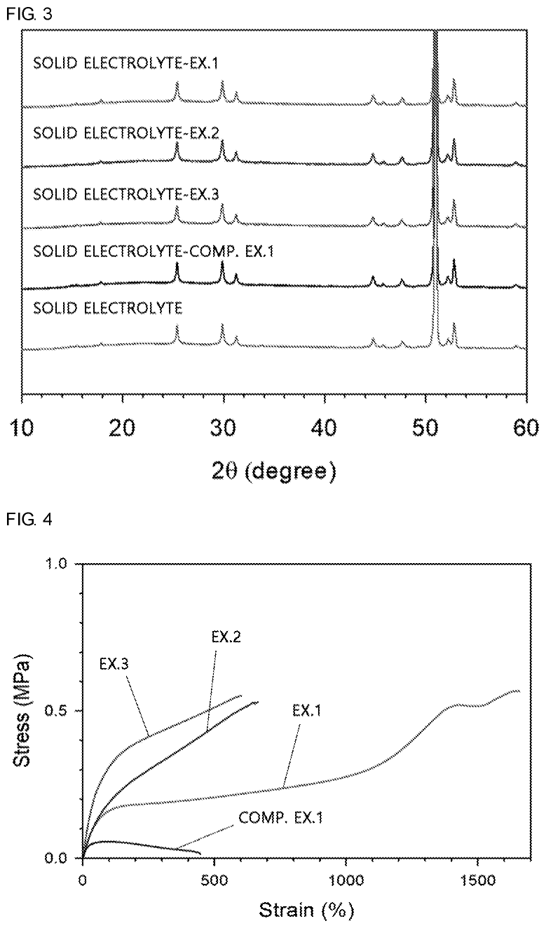

To determine the miscibility of the binder composition for an all-solid-state battery according to each of Examples 1-3 and Comparative Example 1 with a sulfide-based solid electrolyte, X-ray diffractometry (XRD) was carried out. The results are shown in FIG. 3.

FIG. 3 is a graph illustrating the results of X-ray diffractometry (XRD) of the sulfide-based solid electrolyte layer prepared by mixing the binder composition for an all-solid-state battery according to each of Examples 1-3 and Comparative Example 1 with a sulfide-based solid electrolyte. Referring to FIG. 3, each of Examples 1-3 and Comparative Example 1 shows peaks similar to the peaks of the solid electrolyte. Therefore, it can be seen that even when the binder is mixed with a sulfide-based solid electrolyte, the crystal structure phase does not collapse but is retained as it is.

### Test Example 3: Evaluation of Elastic Force and Tensile Strength

The binder composition for an all-solid-state battery according to each of Examples 1-3 and Comparative Example 1 was evaluated in terms of tensile strength. The results are shown in FIG. 4. The elastic force and tensile strength were evaluated by using a stress-strain curve.

FIG. 4 is a graph illustrating the tensile strength test results of the binder composition for an all-solid-state battery according to each of Examples 1 to 3 and Comparative Example 1. Referring to FIG. 4, it can be seen that the binder according to each of Examples 1-3 shows significantly improved elastic force and tensile strength after vulcanization. The elastic force can be determined as the initial gradient, and a higher gradient means higher elasticity. It can be also seen that Example 1 is the most stretched by virtue of its high softness.

### Test Example 4: Evaluation of Charge/Discharge Performance

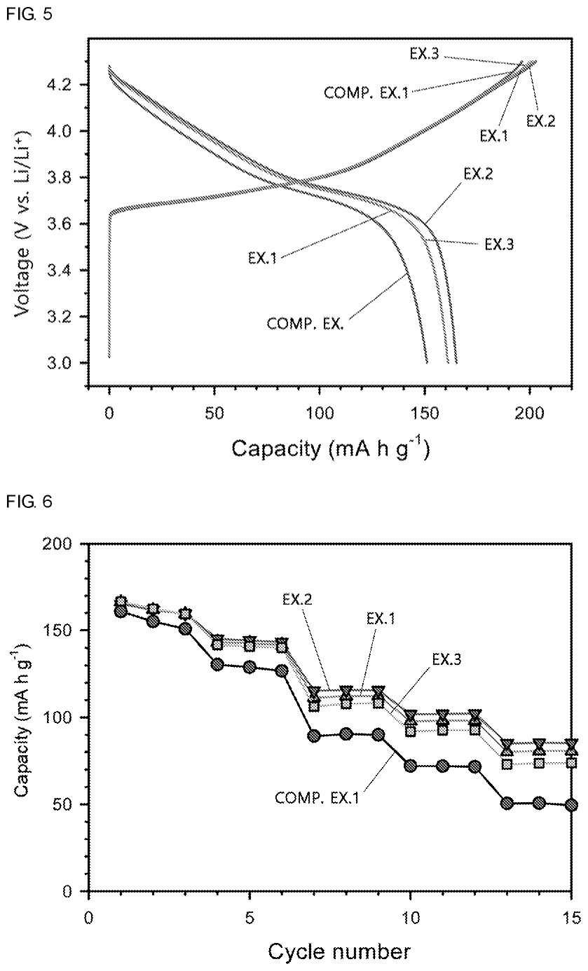

The electrode according to each of Examples 1-3 and Comparative Example 1 was applied to an all-solid-state battery, and the charge/discharge performance, rate characteristics depending on cycle number and life characteristics were evaluated. The results are shown in FIG. 5 to FIG. 7.

FIG. 5 is a graph illustrating the results of evaluation of the initial charge/discharge cycle voltage Vs. capacity of the all-solid-state battery including the electrode according to each of Examples 1-3 and Comparative Example 1. Referring to FIG. 5, it can be seen that each of Examples 1-3 provides improved discharge capacity as compared to Comparative Example 1.

FIG. 6 is a graph illustrating the results of evaluation of the rate characteristics of the all-solid-state battery including the electrode according to each of Examples 1-3 and Comparative Example 1, depending on the charge/discharge cycle. Referring to FIG. 6, it can be seen that each of Examples 1-3 shows reduced overvoltage and significantly improved rate characteristics, as compared to Comparative Example 1.

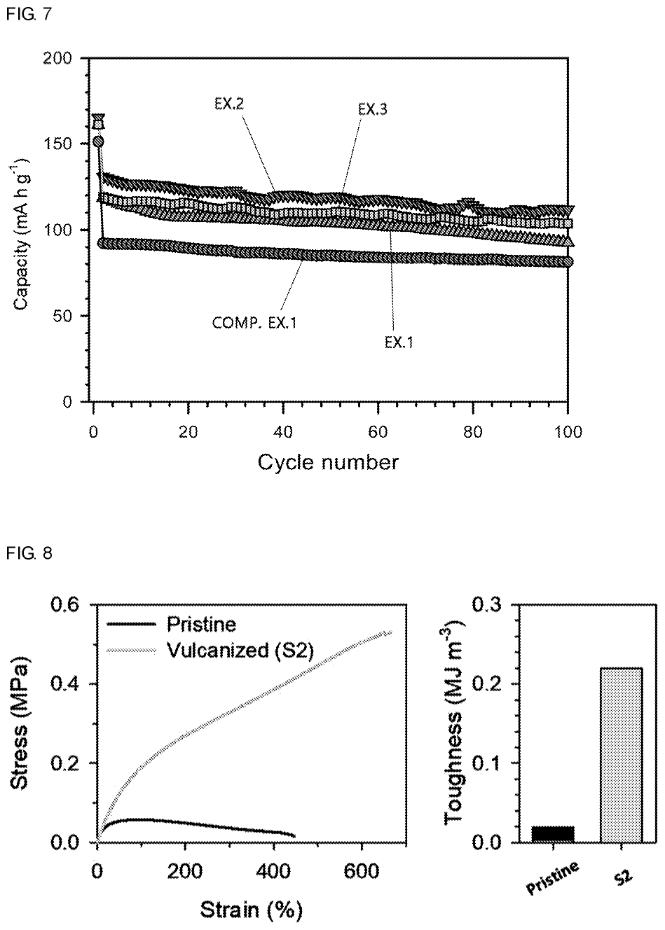

FIG. 7 is a graph illustrating the results of evaluation of the life characteristics of the all-solid-state battery including the electrode according to each of Examples 1-3 and Comparative Example 1, depending on the charge/discharge cycle. Referring to FIG. 7, it can be seen that Comparative Example 1 shows a low discharge capacity of 90 mAh/g after 100 charge/discharge cycles, but each of Examples 1-3 maintains a high discharge capacity of 120 mAh/g for a long time after 100 cycles and shows improved battery performance. Particularly, it can be seen that Example 2 maintains the highest discharge capacity for a long time.

FIG. 8 is a stress-strain graph obtained through the tensile strength test of the binder for an all-solid-state battery according to each of Example 2 and Comparative Example 1. Referring to FIG. 8, it can be seen that Example 2 has a higher strain and fracture toughness as compared to Comparative Example 1.

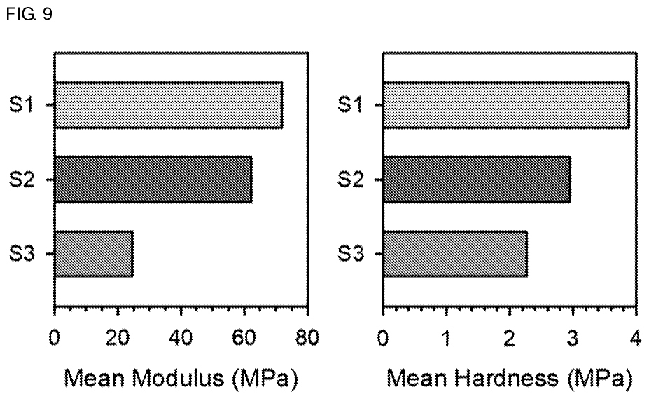

FIG. 9 is a graph illustrating the mechanical properties of the binder for an all-solid-state battery according to each of Examples 1-3 and Comparative Example 1, as determined by the nano-indentation method. Referring to FIG. 1 and FIG. 9, it can be seen that Examples 1-3 show mechanical properties, such as Young's modulus and hardness, varying with the type and ratio of carbon-sulfur bonding.

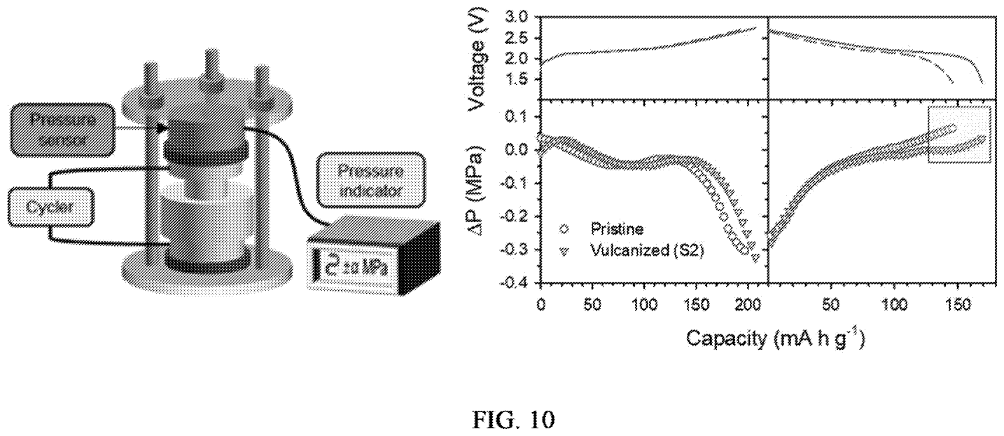

FIG. 10 is a schematic view and graph illustrating the real-time pressure measurement test depending on the charge/discharge cycle of the all-solid-state battery including the electrode according to each of Example 2 and Comparative Example 1. Referring to FIG. 10, it can be seen that Example 2 shows a higher discharge capacity at a lower driving pressure of 2 MPa, as compared to Comparative Example 1. It can be also seen that an irreversible increase in pressure is low at the end of discharge. It is thought this is because Example 2 shows a smaller irreversible increase in volume caused by generation of voids, as compared to Comparative Example 1.

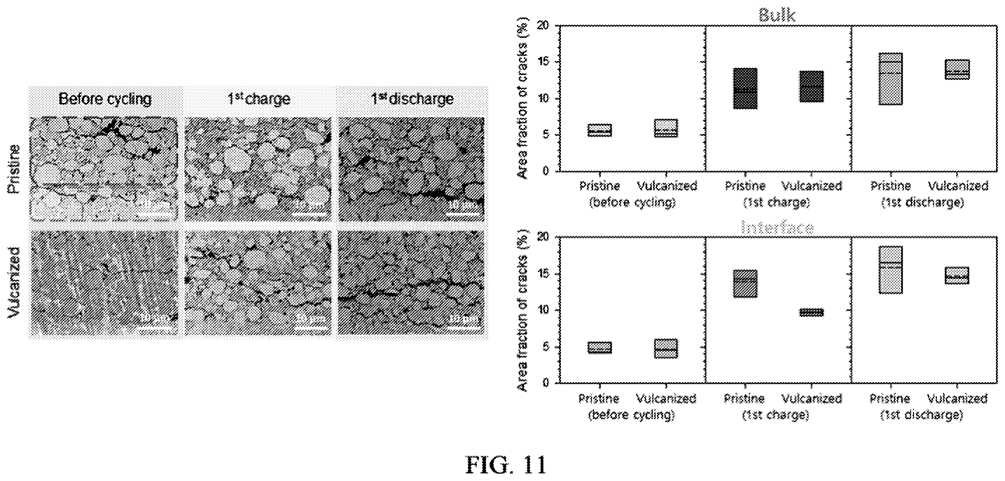

FIG. 11 is a scanning electron microscopic image illustrating the all-solid-state battery including the electrode according to each of Example 2 and Comparative Example 1 depending on the charge/discharge cycle. Referring to FIG. 10 and FIG. 11, it can be seen that generation of voids is inhibited in the case of Example 2 at a low driving pressure of 2 MPa, as compared to Comparative Example 1.

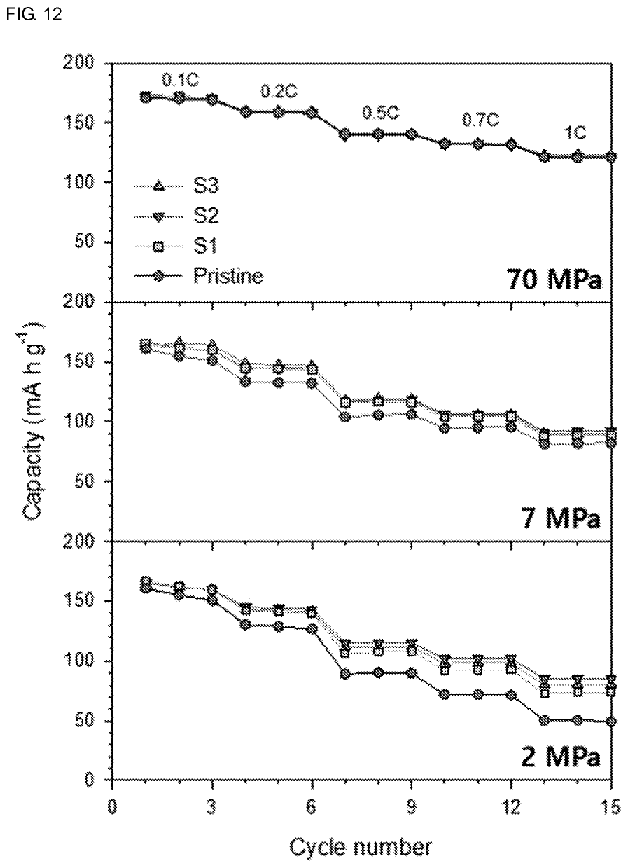

FIG. 12 is a graph illustrating the test results of rate characteristics of the all-solid-state battery including the electrode according to each of Examples 1-3 and Comparative Example 1, depending on the battery driving pressure. Referring to FIG. 12, it can be seen that each of Examples 1-3 shows reduced overvoltage and significantly improved rate characteristics, as compared to Comparative Example 1.

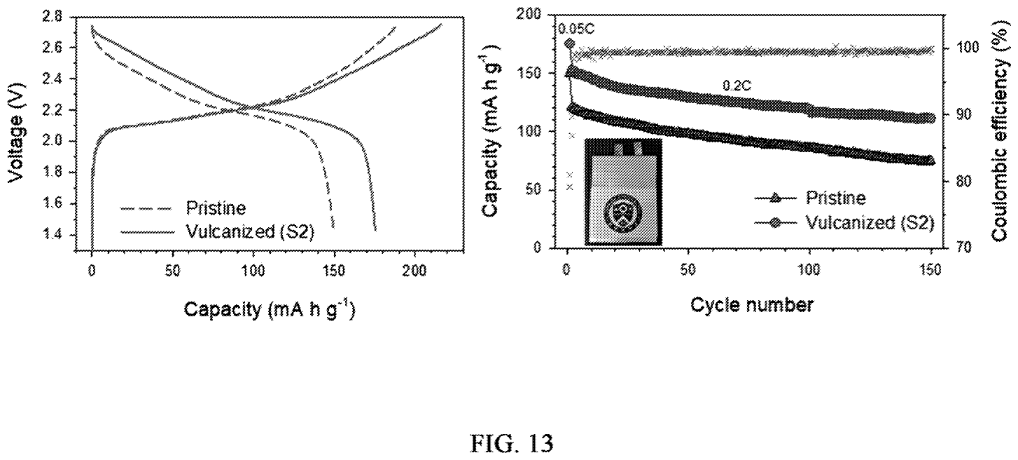

FIG. 13 shows a graph illustrating the initial charge/discharge cycle voltage Vs. capacity test results of the pouch-type all-solid-state battery including the electrode according to each of Example 2 and Comparative Example 1 and a solid electrolyte membrane, and a graph illustrating the life characteristics depending on the charge/discharge cycle thereof. Referring to FIG. 13, it can be seen that Example 2 shows significantly improved initial charge/discharge capacity, coulombic efficiency and life characteristics as compared to Comparative Example 1.

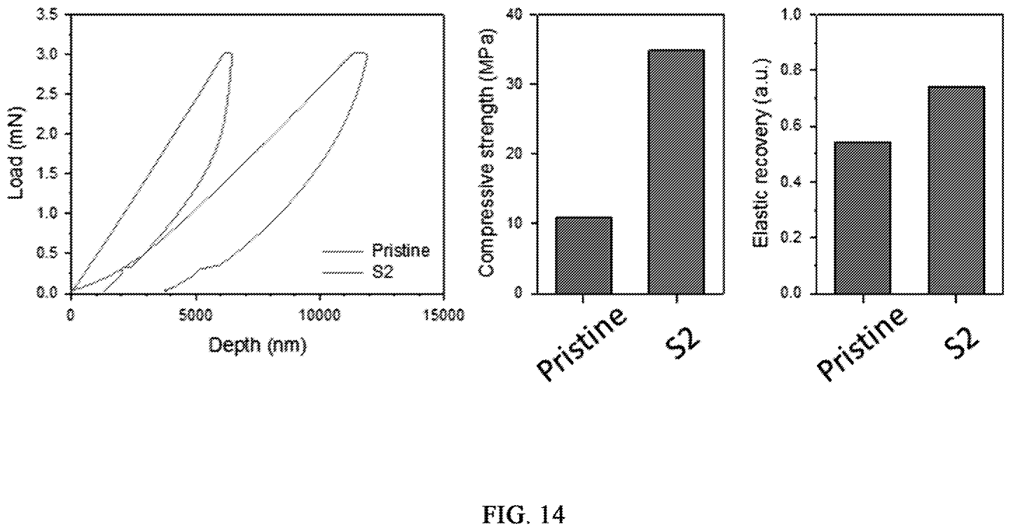

FIG. 14 is a graph illustrating the mechanical properties of the electrode according to each of Example 2 and Comparative Example 1, as determined by the nano-indentation method. Referring to FIG. 14, it can be seen that Example 2 shows significantly improved mechanical properties, such as compressive strength and elastic recovery, as compared to Comparative Example 1.

As can be seen from the foregoing, the binder for an all-solid-state battery according to each of Examples 1-3 includes a polymer having a three-dimensional network structure formed through a vulcanization step of crosslinking the polymer chains with sulfur. In this manner, the binder has such a level of physical properties that it may prevent separation from an electrode substrate and electrode cracking during the drying of the electrode, and may inhibit swelling and shrinking of the active material in the electrode and to allow the materials in the electrode to be in contact with one another during the operation of a battery, thereby providing significantly improved battery performance.

We claim:

1. A binder for an all-solid-state battery, having a three-dimensional structure formed by the covalent bonding of carbon with sulfur through the heat treatment of a binder composition, wherein the binder composition comprises, based on 100 parts by weight of a polymer having unsaturated carbon double bonds, 1-30 parts by weight of a sulfur donor, and an organic solvent, and optionally includes 0.5-4 parts by weight of a vulcanization accelerator, 3-10 parts by weight of a first activating agent, and 1-4 parts by weight of a second activating agent.

2. The binder for an all-solid-state battery according to claim 1, wherein the polymer having unsaturated carbon double bonds is at least one selected from the group consisting of natural rubber (NR), butadiene rubber (BR), styrene-butadiene rubber (SBR), acrylonitrile-butadiene rubber (NBR), isobutylene-isoprene rubber (IIR) and ethylene propylene rubber (EPDM),
the sulfur donor is elementary sulfur or an organic sulfur donor,
the organic sulfur donor is at least one selected from the group consisting of thiuram disulfide (TMTD), 4,4′-dithiodimorpholine (DTDM), dipentamethyl thiuram tetrasulfide (DPTT) and thiocarbamyl sulfenamide (OTOS),
the vulcanization accelerator is at least one selected from the group consisting of thiazole-based, aldehyde amine-based, guanidine-based, thiophosphate-based, sulfenamide-based, thiourea-based, thiuram-based, dithiocarbamate-based and xanthate-based compounds, and
the organic solvent is at least one selected from the group consisting of butyl butyrate, hexyl butyrate, benzyl acetate o-xylene, toluene, dibromomethane and anisole.

3. The binder for an all-solid-state battery according to claim 1, wherein the first activating agent is ZnO, Zn₂SiO₄ or a mixture thereof, and
the second activating agent is stearic acid.

4. The binder for an all-solid-state battery according to claim 1, which comprises the first activating agent and the second activating agent mixed at a weight ratio of 3-5:1.

5. The binder for an all-solid-state battery according to claim 1, which shows a polysulfide bond peak and a disulfide bond peak in a wavelength range of 435-445 cm⁻¹ and 500-510 cm⁻¹, respectively, as analyzed by Raman spectrometry, and
the ratio of the intensity of the polysulfide bond peak/disulfide bond peak is 1.1-3.1.

6. A solid electrolyte layer for an all-solid-state battery, comprising the binder as defined in claim 1 and a sulfide-based solid electrolyte.

7. An electrode for an all-solid-state battery, comprising the binder as defined in claim 1, a sulfide-based solid electrolyte and an electrode active material.

8. An all-solid-state battery, comprising a positive electrode layer; a negative electrode layer; and the solid electrolyte layer as defined in claim 6, interposed between the positive electrode layer and the negative electrode layer, wherein at least one of the positive electrode layer and the negative electrode layer comprises the binder as defined in claim 1.

9. A device comprising the all-solid-state battery as defined in claim 8, which is any one selected from a transport device, an energy storage device and a communication device.

10. A method for preparing a binder for an all-solid-state battery, which includes a step of preparing a binder for an all-solid-state battery, having a three-dimensional structure formed by covalent bonding of carbon with sulfur through the heat treatment of a binder composition, wherein the binder composition comprises 100 parts by weight of a polymer having unsaturated carbon double bonds, 1-30 parts by weight of a sulfur donor and an organic solvent, and further comprises 0.5-4 parts by weight of a vulcanization accelerator, 3-10 parts by weight of a first activating agent and 1-4 parts by weight of a second activating agent.

11. The method for preparing a binder for an all-solid-state battery according to claim 10, wherein the polymer having unsaturated carbon double bonds is at least one selected from the group consisting of natural rubber (NR), butadiene rubber (BR), styrene-butadiene rubber (SBR), acrylonitrile-butadiene rubber (NBR), isobutylene-isoprene rubber (IIR) and ethylene propylene rubber (EPDM),
the sulfur donor is elementary sulfur or an organic sulfur donor,
the organic sulfur donor is at least one selected from the group consisting of thiuram disulfide (TMTD), 4,4′-dithiodimorpholine (DTDM), dipentamethyl thiuram tetrasulfide (DPTT) and thiocarbamyl sulfenamide (OTOS),
the vulcanization accelerator is at least one selected from the group consisting of thiazole-based, aldehyde amine-based, guanidine-based, thiophosphate-based, sulfenamide-based, thiourea-based, thiuram-based, dithiocarbamate-based and xanthate-based compounds, and
the organic solvent is at least one selected from the group consisting of butyl butyrate, hexyl butyrate, benzyl acetate o-xylene, toluene, dibromomethane and anisole.

12. The method for preparing a binder for an all-solid-state battery according to claim 10, wherein the first activating agent is ZnO, Zn₂SiO₄ or a mixture thereof, and
the second activating agent is stearic acid.

13. The method for preparing a binder for an all-solid-state battery according to claim 10, wherein the binder for an all-solid-state battery comprises the first activating agent and the second activating agent mixed at a weight ratio of 3-5:1.

14. The method for preparing a binder for an all-solid-state battery according to claim 10, wherein the heat treatment in the step of preparing a binder for an all-solid-state battery is carried out at a temperature of 120-180° C. under vacuum or inert atmosphere.

15. The method for preparing a binder for an all-solid-state battery according to claim 10, wherein the polymer having unsaturated carbon double bonds is butadiene rubber (BR),
the sulfur donator is elementary sulfur,
the vulcanization accelerator is 2-mercaptobenzothiazole (MBT),
the first activating agent is ZnO,
the second activating agent is stearic acid,
the binder for an all-solid-state battery comprises first activating agent and the second activating agent are mixed at a weight ratio of 4-5:1,
the organic solvent is butyl butyrate,
the heat treatment in the step of preparing a binder for an all-solid-state battery is carried out at a temperature of 140-160° C. under vacuum for 10-14 hours, and
the binder for an all-solid-state battery shows a polysulfide bond peak and a disulfide bond peak in a wavelength range of 435-445 cm⁻¹ and 500-510 cm⁻¹, respectively, as analyzed by Raman spectrometry, wherein the ratio of the intensity of the polysulfide bond peak/disulfide bond peak may be 1.4-1.8.
